(19) United States
(12) Patent Application Publication
(10) Pub. No.: US 2003/0126897 A1
(43) Pub. Date: Jul. 10, 2003

(54) Lock

(76) Inventor: Johnny Shen, Yungho City (TW)

Correspondence Address: Rabin & Berdo, P.C., Suite 500, 1101 14th Street, Washington, DC, 20005, US

(21) Appl. No.: 10/331,770

(22) Filed: Dec. 31, 2002

(30) Foreign Application Priority Data
Jan. 7, 2002 (TW) 091200032

(51) Int. Cl. E05B 29/04

(52) U.S. Cl. 70/492; 70/495

(57) ABSTRACT

A lock includes a hollow casing, a core rotatably received in the hollow casing, a key detachably inserted into the core and having a pattern on both sides of the key, locking plates movably received in the slits and at least one of the locking plates being extending out of a corresponding slit and into at least one elongated hole to interfere rotation of the core and a positioning plate received in the hollow casing and being movable with respect to the core. Movement of the positioning plate abuts the locking plates to secure movement of the locking plates, such that only the locking plates are retracted into the core by the pattern of the key to avoid interference with the rotation of the core, whereby the core is immovable.

### BACKGROUND OF THE INVENTION

1. Field of the Invention

The present invention relates to a lock, and more particularly to a lock which is able to prevent unauthorized personnel from gradually breaking the sequence of the locking plate so as to unlock the lock.

2. Description of Related Art

A conventional lock normally is equipped with multiple locking plates sequentially arranged in the core of the lock. The locking plates each have a predetermined position so that when the key is retracted from the keyhole, the locking plates abut a periphery defining a slot in the casing of the lock. The abutment of the locking plates stops rotation of the core so that unless the correct key is applied, the core is secured and can not be rotated to unlock the lock. However, nowadays some people trying to steal things from the others often find a way to gradually break the abutment of the locking plates. That is, these people use special tools to break the abutment of the locking plates, one-by-one, to the periphery defining the slot in the casing, which uses the same principle as that to unlock a combination lock. One by one, the sequence of the locking plates is broken and thus the lock is unlocked. Patents relating to how to strengthen the structure of the lock to accomplish the purpose of burglar proofing are numerous. However, it seems that none of them is able to successfully stop the unauthorized personnel to damage the sequence of the locking plates.

To overcome the shortcomings, the present invention tends to provide an improved safety lock to mitigate and obviate the aforementioned problems.

### SUMMARY OF THE INVENTION

The primary objective of the present invention is to provide an improved safety lock to prevent unauthorized personnel to break the sequence of the locking plates to unlock the lock

Another objective of the present invention is to provide an improved safety lock having multiple locking plates movably received in a core and a positioning plate detachably connected to the locking plates to secure the locking plates when the core is rotated such that only the correct key inserted into the core is able to retract the locking plates protruding out of the core and to rotate the core.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the present invention;

FIG. 2 is a perspective view of the lock in assembly, wherein a half of the lock is removed for clarity;

FIG. 3 is a cross sectional view of the lock in FIG. 2;

FIG. 4 is a cross sectional view of the lock in FIG. 2;

FIG. 5 is a schematic view of applying a key in the keyhole in the core to rearrange the locking plates;

FIG. 6 is a cross sectional view taken by the line 6-6 in FIG. 5;

FIG. 7 is a cross sectional view showing that abutment of the positioning plate to a periphery defining the positioning recess forces the positioning plate to engage with the locking plates; and

FIG. 8 is a cross sectional view showing the inner structure of the lock after the core is rotated 90

### DETAILED DESCRIPTION OF THE PREFERRED EMBODIMENT

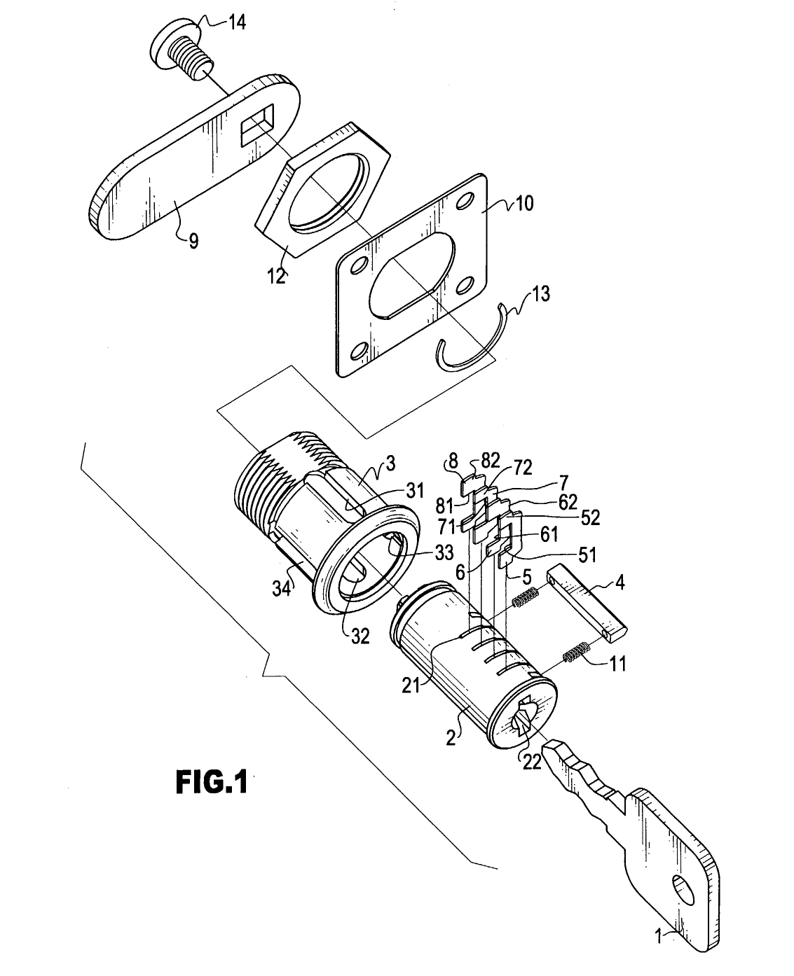

With reference to FIG. 1, the safety lock in accordance with the present invention has a core (2), a casing (3), a positioning plate (4), multiple locking plates (5,6,7,8) (four locking plates are shown in this embodiment), a latching plate (9) securely connected to the core (2) by a securing element (14) (preferably a screw), a baffle (10), springs (11), a nut (12) and a C clip (13).

The core (2) has four slits (21) defined in a periphery of the core (2) to correspond to the locking plates (5,6,7,8) and a keyhole (22) longitudinally extending into the core (2) for receiving a key (1).

The casing (3) is a hollow cylinder and has at least one elongated hole (31) defined through a periphery of the casing (3). Four elongated holes (31,32,33,34) are shown in this embodiment. The C clip (13) is provided to correspond to a distal end of the core (2) so as to secure the core (2) inside the casing (3) after the core (2) is received in the casing (3).

The nut (12) is threadingly connected to the distal end of the core (2) so as to sandwich the baffle (10) with an outer periphery of the casing (3).

The latching plate (9) securely connected to the distal end of the core (2) by the securing element (14) is thus able to move when the core (2) moves so that the lock of the present invention is able to perform a lock and unlock function.

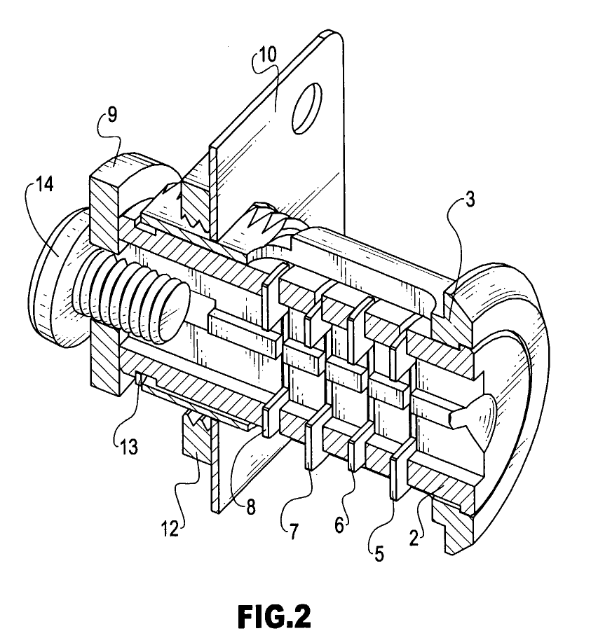

With reference to FIG. 2 and still taking FIG. 1 for reference, it is noted that the locking plates (5,6,7,8) each have a cutout (51,61,71,81) respectively defined in a mediate portion of each of the locking plates (5,6,7,8) and each of the locking plates (5,6,7,8) has a head (52,62,72,82) formed on top of each of the locking plates (5,6,7,8) and a length different from the others. When the lock of the present invention is in assembly, the locking plates (5,6,7,8) are inserted into the slits (21) of the core (2) and the positioning plate (4) is attached to a side of the core (2) with the springs (11) sandwiched between the positioning plate (4) and an outer periphery of the core (2). Then the core (2) together with the locking plates (5,6,7,8) received inside the core (2) and the positioning plate (4) attached to the outer periphery of the core (2) are inserted into the casing (3). The C clip (13) is applied to mount on the distal end of the core (2) to prevent the core (2) from falling out of the casing (3). After the baffle (10) is securely sandwiched by the outer periphery of the casing (3) and the nut (12), the securing element (14) extends through the latching plate (9), the nut (12) and the baffle (10) to securely connect the latching plate (9) to the core (2).

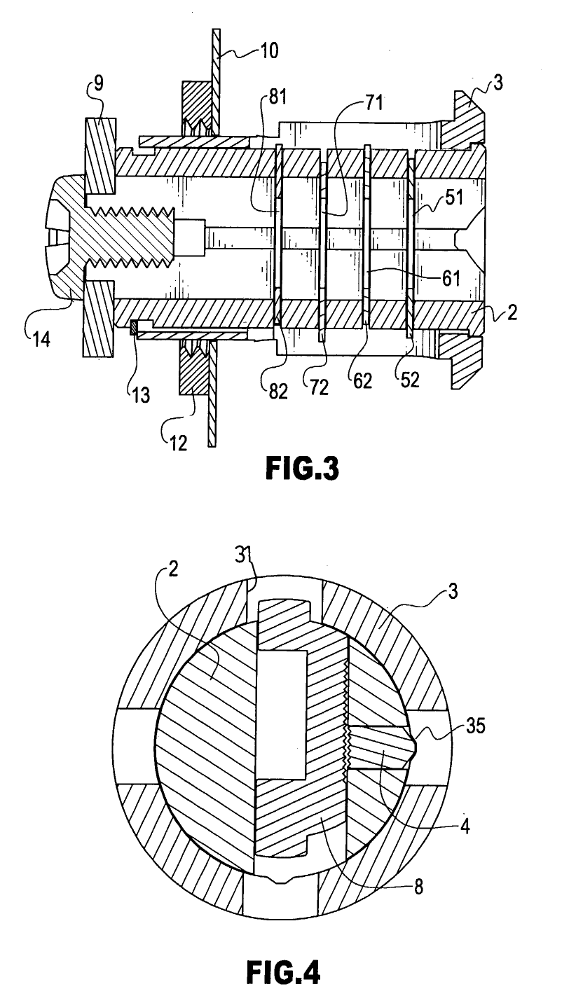

With reference to FIGS. 3 and 4, after the assembly, it is noted that the locking plates (5,6,7,8) are respectively received in the corresponding slits (21) in the core (2). Because each of the locking plates (5,6,7,8) has a length different from the others, the positions of the locking plates (5,6,7,8) are different inside the slits (21). However, there is one thing in common for all the locking plates (5,6,7,8), that is, all the cutouts (51,61,71,81) communicate with one another inside the casing (3). Due to the different positions of the locking plates (5,6,7,8) in the slits (21), some (or all) of the locking plates (5,6,7,8) have their heads (52,62,72,82) protruding out of the corresponding elongated hole (31). Meanwhile, the positioning plate (4) is received in a positioning recess (35) defined in an inner periphery of the casing (3).

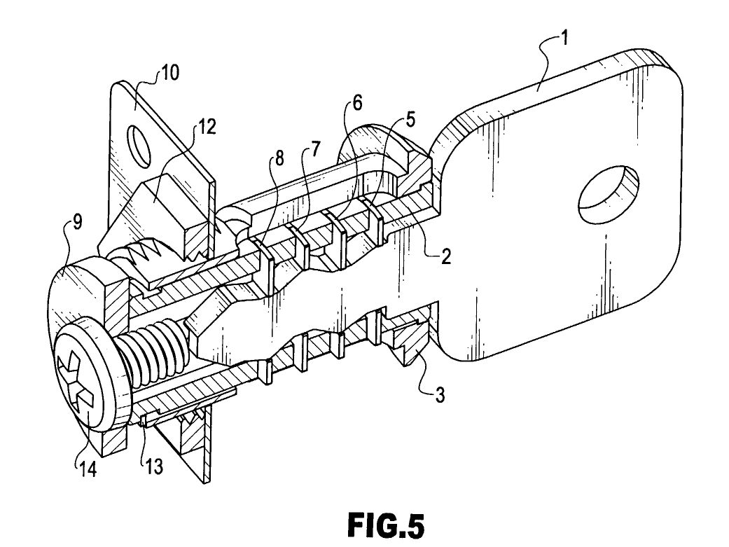

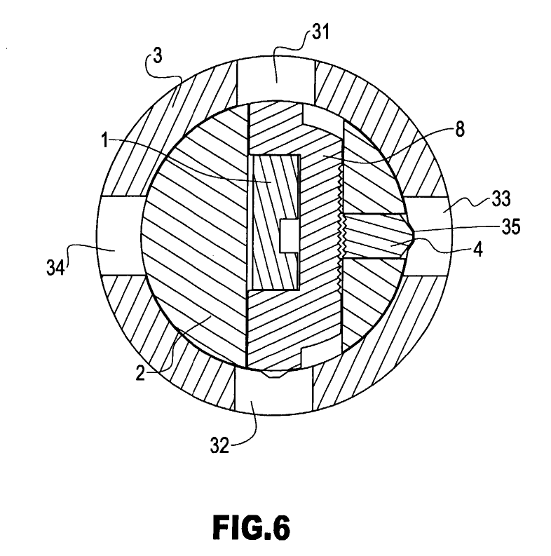

With reference to FIGS. 5 and 6, when a correct key (1) is inserted into the keyhole (22), the patterns on both sides of the key (1) force the locking plates (5,6,7,8) to move inside the slits (21), which results in that all the locking plates (5,6,7,8) are retracted inside the slits (21). That is, all the heads (52,62,72,82) of the locking plates (5,6,7,8) are within the slits (21). Thereafter, when the operator rotates the key (1) to drive the core (2) to rotate accordingly, because there are no heads (52,62,72,82) interfering the rotation of the core (2), the core (2) is able to rotate freely.

Comparing FIG. 4 with FIG. 6, it is noted that only after the correct key (1) is inserted into the keyhole (22) of the core (2), the locking plates (5,6,7,8) are retracted inside the slits (21) to allow the core (2) to rotate freely.

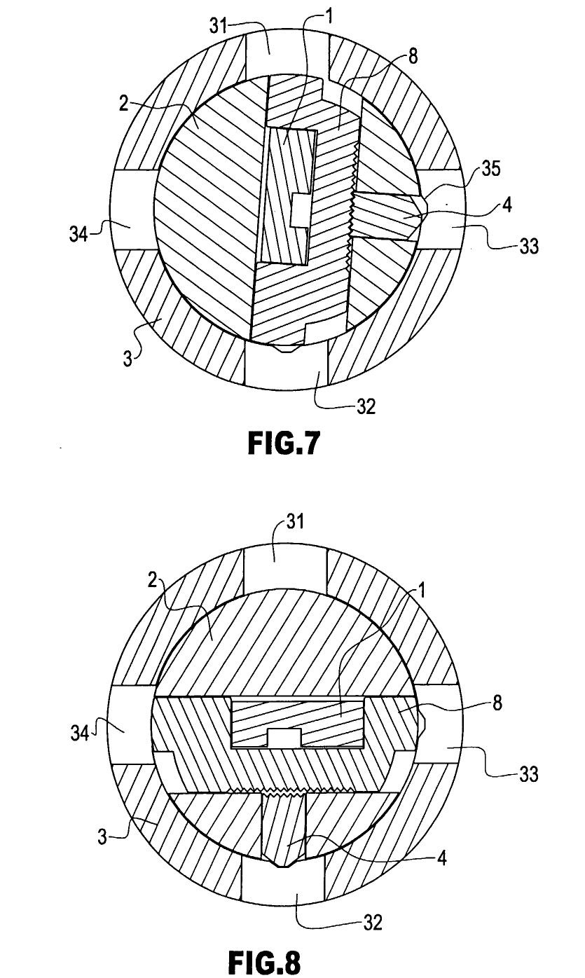

With reference to FIG. 7, when the key (1) is first rotated, the rotation of the core (2) drives the positioning plate (4) to move inside the casing (3), which forces the positioning plate (4) to leave the positioning recess (35). When the positioning plate (4) leaves the positioning recess (35) and engages the inner periphery of the casing (3), the inner periphery of the casing (3) forces the positioning plate (4) to move toward the locking plates (5,6,7,8) to abut the locking plates (5,6,7,8). Thus when the core (2) rotates, the positioning plate (4) also rotates.

With reference to FIG. 7, as previously described, if the casing (3) has only two elongated holes (31,32), the core (2) will have to rotate 180° to relocate the positioning plate (4) in the elongated hole (32) and to enable the latching plate (9) to perform a locking function.

However, when the key or instrument inserted into the keyhole (22) is not correct, such as a screwdriver or a wire, because the elongated hole (31) has a width larger than a width of the heads (52,62,72,82) (only the head (82) is shown), the lock of the present invention allows the core (2) with an incorrect key to rotate for only a small angle (5°). After the core (2) is rotated by the operator with the incorrect key, the movement of the positioning plate (4) away from the positioning recess (35) makes the positioning plate (4) abut the locking plates (5,6,7,8). Therefore, if the key is not the correct one, the locking plates (5,6,7,8) will not be retracted in the slits (21) and are abutted by the positioning plate (4). Therefore, rotating the incorrect key or a tool that is inserted into the keyhole (22) to rotate the core (2), due to the interference of the heads (52,62,72,82) with the periphery defining the elongated hole (31), the core (2) will not be rotated even with an auxiliary tool trying to unlock the lock.

With the lock of the present invention, unauthorized personnel are not able to use auxiliary tools to unlock the lock to retract the locking plates (5,6,7,8). Furthermore, the movement of the locking plates (5,6,7,8) is driven solely by the patterns on both sides of the key (1) without assistance of auxiliary springs as those used in the conventional lock so that the structure of the present invention is simple and cost efficient.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a lock having a hollow casing provided with at least one elongated hole defined through a periphery of the casing, a core rotatably received in the casing and provided with slits defined in a periphery of the core to selectively communicate with the at least one elongated hole, a positioning plate movably attached to an outer periphery of the core to rotate with the core, wherein the improvement comprises:
multiple locking plates are received in the slits of the core and at least one of the locking plates protrudes out of a corresponding slit of the core and into the at least one elongated hole, the locking plates are adapted to be moved by a pattern on both sides of a key extending into a keyhole of the core such that the locking plates are retracted into the slits only by a correct key.

2. The lock as claimed in claim 1, wherein the rotation of the core drives the positioning plate to rotate, which makes the positioning plate leave a positioning recess adapted to be defined in an inner periphery of the casing and movement of the positioning plate abuts the locking plates.

3. The lock as claimed in claim 2, wherein movement of the locking plates by the pattern of the correct key allows the locking plates to be retracted inside the core to avoid interference with the rotation of the core.

4. In a lock having a hollow casing with at least one elongated hole defined through a periphery of the hollow casing, a core rotatably received in the hollow casing and having slits defined in a periphery of the core, a key detachably inserted into the core and having a pattern on both sides of the key, locking plates movably received in the slits and at least one of the locking plates being extending out of a corresponding slit and into the at least one elongated hole to interfere rotation of the core and a positioning plate received in the hollow casing and being movable with respect to the core, wherein the improvement comprises:
each of the locking plates has a cutout to communicate with one another so that the key is able to extend through the communicated cutouts of the locking plates and to retract the at least one locking plate which protrudes out of the corresponding slit and into the at least one elongated hole of the casing.

5. In a lock having a hollow casing with at least one elongated hole defined through a periphery of the hollow casing, a core rotatably received in the hollow casing and having slits defined in a periphery of the core, a key detachably inserted into the core and having a pattern on both sides of the key, locking plates movably received in the slits and at least one of the locking plates being extending out of a corresponding slit and into the at least one elongated hole to interfere rotation of the core and a positioning plate received in the hollow casing and being movable with respect to the core, wherein the improvement comprises:
movement of the positioning plate abuts the locking plates to secure movement of the locking plates, such that only the locking plates are retracted into the core by the pattern of the key to avoid interference with the rotation of the core, whereby the core is immovable.

6. In a lock having a hollow casing provided with at least one elongated hole defined through a periphery of the casing, a core rotatably received in the casing and provided with slits defined in a periphery of the core to selectively communicate with the at least one elongated hole, a positioning plate movably attached to an outer periphery of the core to rotate with the core, wherein the improvement comprises:
multiple locking plates which are adapted to be received in the core are movable in such a way that the locking plates are adapted to be retracted into the slits of the core only by a correct key.

7. The lock as claimed in claim 6, wherein multiple locking plates are received in the slits of the core and at least one of the locking plates protrudes out of a corresponding slit of the core and into the at least one elongated hole, the locking plates are adapted to be moved by a pattern on both sides of a key extending into a keyhole of the core such that the locking plates are retracted into the slits only by a correct key.

8. The lock as claimed in claim 7, wherein the rotation of the core drives the positioning plate to rotate, which makes the positioning plate leave a positioning recess adapted to be defined in an inner periphery of the casing and movement of the positioning plate abuts the locking plates.

9. The lock as claimed in claim 8, wherein movement of the locking plates by the pattern of the correct key allows the locking plates to be retracted inside the core to avoid interference with the rotation of the core.
